(19) United States
(12) Patent Application Publication
(10) Pub. No.: US 2012/0248961 A1
(43) Pub. Date: Oct. 4, 2012

(54) LED BULB WITH HEAT DISSIPATER

(75) Inventor: Chyi-Lang LAI, New Taipei City (TW)

(73) Assignee: Chicony Power Technology Co., Ltd.

(21) Appl. No.: 13/074,053

(22) Filed: Mar. 29, 2011

(51) Int. Cl. H01J 61/52

(52) U.S. Cl. 313/46

(57) ABSTRACT

A LED bulb has a heat dissipater. The LED bulb includes a base, a heat dissipater, a LED module and a cap. The base has a conducting portion and an isolation tube positioned at a bottom portion of the conducting portion. The heat dissipater is assembled to the isolation tube. The heat dissipater has a hollow tunnel and a plurality of fins extending perpendicularly and positioned with an interval from one another in a radial fashion. The fins have an outer flange connected to a heat dissipation ring, and the heat dispensing ring is circularly connected to the fins. The LED module has a circuit board fixed to the heat dissipater and a plurality of LED scattered on the circuit board. The cap is assembled to the heat dissipater to house the LED module. The LED bulb increases the air circulation and accordingly promotes the heat dissipation effect.

### BACKGROUND

1. Technical Field

The present invention relates to an LED. More particularly, the present invention relates to an LED bulb with a heat dissipater.

2. Related Art

Due to the continuously upgraded functions of the LED, various types of LED bulbs are available on the market to replace the conventional incandescent bulb. Referring to FIG. 9, a LED bulb 1′ of the prior art, because the LED bulb 1′ has a high power LED 10a producing high temperature, therefore, a plurality of fins 20′ are positioned at the housing in order to increase the heat dissipation area. However, this design can only benefit in increasing the heat dissipation area but not the air circulation. To exchange air outside the fins 20′ without air circulation thus the effect of heat dispensing is limited.

Furthermore, the fins 20′ of the LED 10′ are mostly formed by the die casting process. Comparing with the conventional aluminum fins formed in the extrusion or stamping process, the die casting formed fins 20′ are not only more costly but also have poor heat dissipating effect due to the material with the lower heat conductivity. Besides, the fins 20′ is manufactured by a complicated after-treatment, for example deburring, surface treatment, lacquering, therefore, the manufacturing process thereof is longer.

### BRIEF SUMMARY

The present invention provides a LED bulb comprising a heat dissipater. By connecting a heat dissipating ring to an outer portion of the fin, not only the heat dissipating area may be increased, but also the heat exchange space in the LED bulb may be increased to allow more incoming air, and thus promote the heat dissipating efficiency.

The present invention provides an LED bulb comprising a heat dissipater. The LED bulb comprises a base, a heat dissipater, a LED module and a cap. The base comprises a conducting portion and an isolation tube positioned at a bottom portion of the conducting portion. The heat dissipater is assembled to the isolation tube. The heat dissipater comprises a hollow tunnel portion, and a plurality of protruded fins horizontally extending and arranged radially in an array separated with a distance from one another. The fins are connected to the heat dissipating ring at an outer flange thereof, wherein the heat dissipating ring is connected to the fins. The LED module comprises a circuit board fixed onto the heat dissipater and a plurality of LED scattered on the circuited board. The cap is assembled to the heat dissipater to house the LED module.

The present invention provides an LED bulb comprising a heat dissipater, and the heat dissipater is formed by an aluminum extrusion process so that the duration of manufacturing process can be shortened and the manufacturing cost can be reduced as well.

The present invention provides a LED bulb comprising a heat dissipater, which include an isolation tube fitted into the hollow tunnel with a simple positioning structure to assemble them together to complete the LED bulb assembly.

Compared to the conventional art, the LED bulb of the present invention comprises a heat dissipating ring positioned at an outer flange of the fins to increase the heat dissipation area, and the space between the heat dissipating ring, fins and the hollow tunnel can substantially promote the air circulation and allow more incoming air to promote the heat dissipation efficiency. Furthermore, the heat dissipater of the present invention is formed by an aluminum extrusion process, and therefore the manufacturing cost, compared to the conventional molding method, can be substantially reduced. The isolation tube of the present invention extends to receive the power supply or other electronic components to isolate the electronic components and the conducting portion to avoid short circuit from occurring. Moreover, the isolation tube is fitted in the hollow tunnel with the simple structure to achieve the assembly. The heat dissipating ring can also be buckled to the fins, thus the LED bulb assembly can be simplified to increase the practicability of the present invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of the LED bulb of the present invention;

FIG. 2 is a perspective view 1 of the LED bulb of the present invention;

FIG. 3 is a perspective view 2 of the LED bulb of the present invention;

FIG. 4 is a perspective view illustrating another side of the LED bulb comprising a heat dissipater of the present invention;

FIG. 5 is an aspect of operation of the LED bulb comprising a heat dissipater of the present invention;

FIG. 6 is an exploded view of the LED bulb according to another embodiment of the present invention;

FIG. 7 is an exploded view of the LED bulb according to another embodiment of the present invention;

FIG. 8 is a sectional view of the LED bulb according to another embodiment of the present invention;

FIG. 9 is a perspective view of the heat dissipater according to another embodiment of the present invention;

FIG. 10 is a top view of a heat dissipater according to another embodiment of the present invention;

FIG. 11 is a top view of a heat dissipater according to another embodiment of the present invention; and

FIG. 12 is an aspect of a conventional LED bulb.

### DETAILED DESCRIPTION

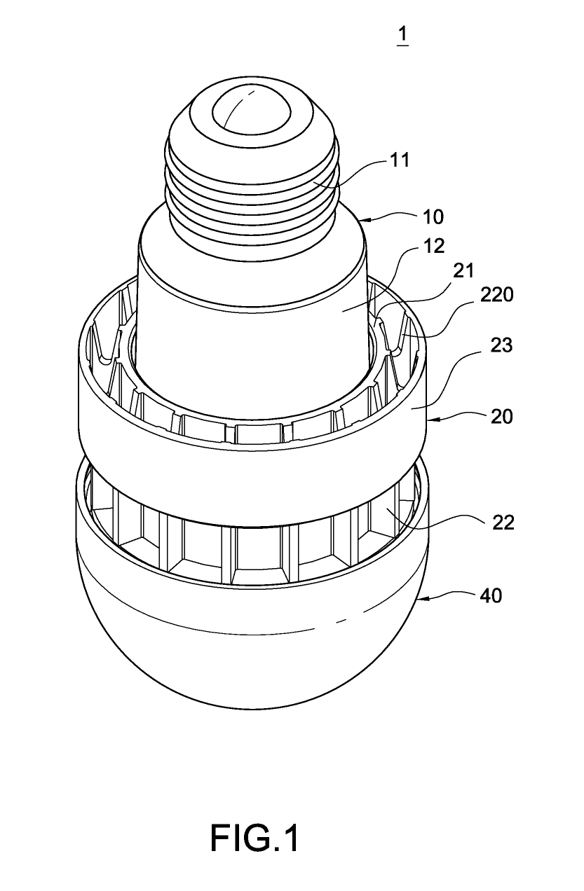

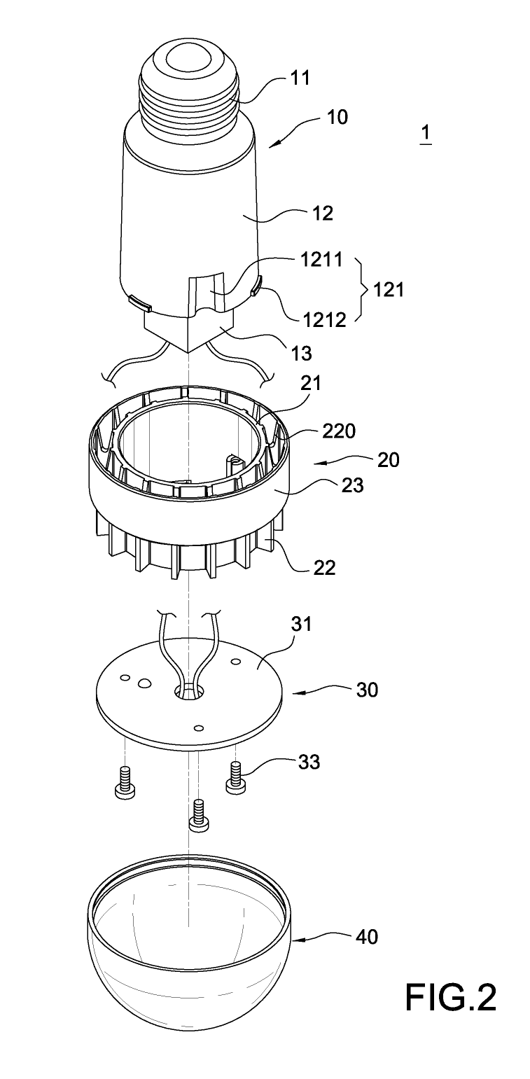

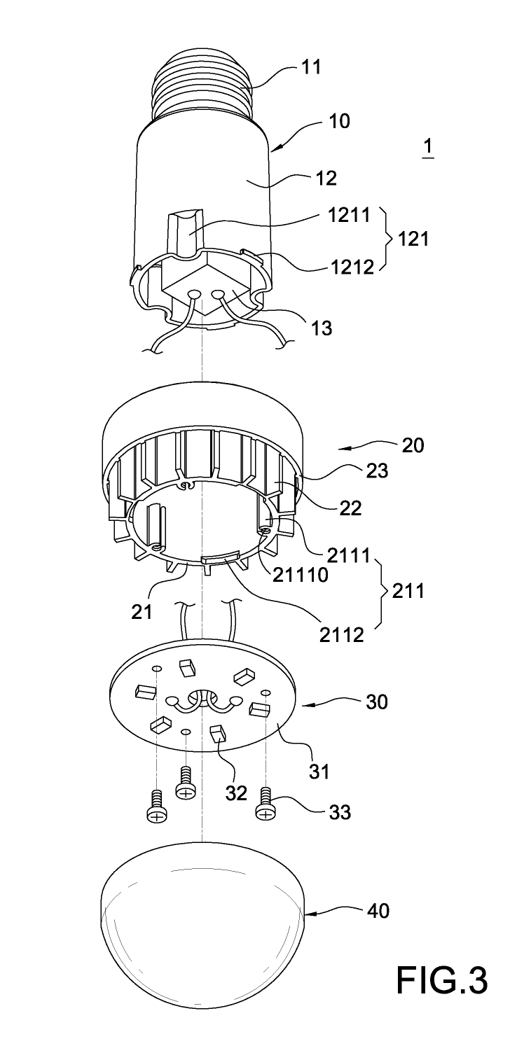

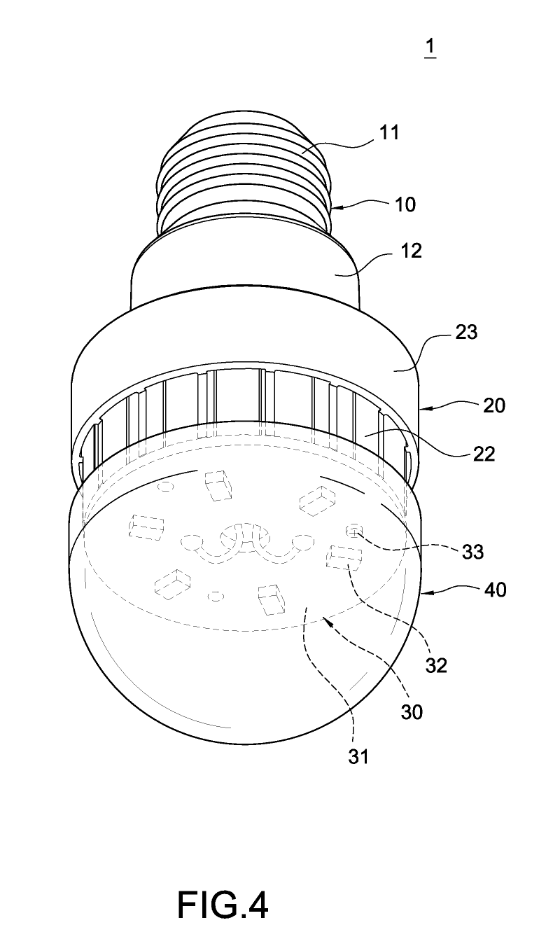

Referring to FIGS. 1 to 4, a perspective, a perspective view 1, a perspective view and a perspective illustrating another side of a LED bulb comprising a heat dissipater of the present invention. The LED bulb 1 comprises a base 10, a heat dissipater 20, a LED module 30 and a cap 40.

The base 10 comprises a conducting portion 11 and an isolation tube 12 positioned at the bottom portion of the conducting portion 11. The conducting portion 11 is connected to the external power supply for the LED bulb 1 to operate. The isolation tube 12 receives the electronic components such as the power supply 13. The isolation tube 12 is made of a nonconductive material to insulate those electronic components from the conducting portion 11 to avoid short circuit.

The heat dissipater 20 is assembled to the isolation tube 12. The isolation tube is manufactured by an aluminum extrusion process. The heat dissipater 20 comprises a hollow tunnel 21, and a plurality of protruded fins 22 extending horizontally and arranged radially in an array separated by a distance from one another. The fins 22 are connected to a heat dissipation ring 23 at an outer flange thereof, and the heat dissipation ring 23 is connected the fins 22.

In the embodiment, the isolation tube 12 comprises a bottom portion fitted into the inner side of the hollow tunnel 21. The isolation tube 12 comprises a first positioning portion 121 and the hollow tunnel 21 comprises a second positioning portion 211 formed in the inner sidewall. The first positioning portion 121 comprises a plurality of arch grooves 1211 and a plurality of blocks 1212. The arch grooves 1211 extend upwards from a bottom flange of the isolation tube 12 in a length. The second positioning portion 211 comprises a plurality of protrusions 2111 and a plurality of indented grooves 2112. The protrusions 2111 respectively have a threaded hole 21110. When the isolation tube 12 fits into the hollow tunnel 21, the arch grooves 1211 have the top portions 12110 supported against the top of the protrusions 2111, and the blocks 1212 buckle into the indented grooves 2112 thus to position the heat dissipater 20 to the base 10.

Furthermore, the heat dissipation ring 23 is positioned on the top side of the fins 22, and a portion of the heat dissipation ring 23 can be removed in a finishing process, for example turning, thus to allow only partial fins 22 to be covered by the heat dissipation ring 23. In this embodiment, the heat dissipation ring 23 and the fins 22 are formed as a one-piece element, and every fin 22 has a V shaped opening 220 formed between the heat dissipation ring 23 and the hollow tunnel 21. The opening 220 is formed to have merely a portion of the fins 22 connected to the hollow tunnel 21, therefore, a larger space is provided for air circulation between the heat dispensing ring 23 and the hollow tunnel 21 to allow the air flow more easily among the fins 22.

The LED module 30 comprises a circuit board 31 fixed onto the heat dissipater 20 and a plurality of LED 31 scattered on the circuit board 31. The circuit board 31 is electrically connected to the power supply 13 and comprises a plurality of positioning holes 310 corresponding to the protrusions 2111. To assemble the LED module 30, screw a plurality of threaded elements 33 are screwed through the positioning holes 310 and positioned in the threaded holes 21110, thus the circuit board 31 can be fixed to the threaded holes 21110. In other words, the circuit board 31 is fixed at the bottom side of the heat dissipater 20.

The cap 40 is made of a transparent or a semitransparent material to assemble to the heat dissipater 20 to house the LED 30.

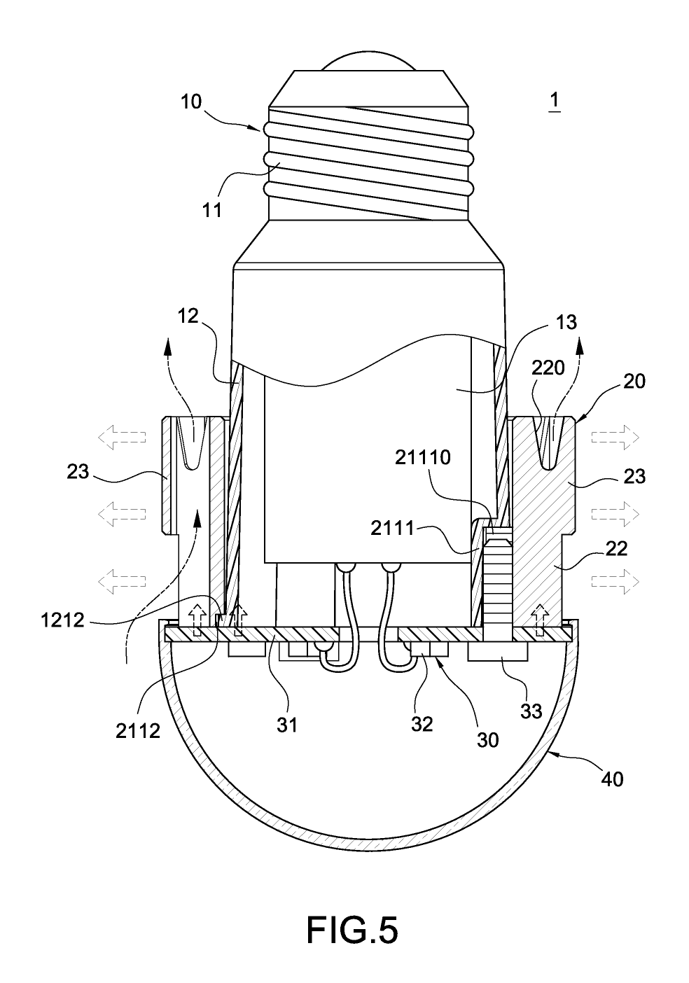

Referring FIG. 5, an aspect of operating the LED bulb comprising a heat dissipater of the present invention is disclosed. When using the LED bulb 1 with the bulb, because the circuit board 31 and the hollow tunnel 21 and the fins 22 of the heat dissipater 20 are connected, therefore, the heat generated by the LED 32 can be directly transferred to the hollow tunnel 21, fins 22 and the heat dissipation ring 23 for heat dissipation. On the other hand, the outer air can freely flow among every fin 22, and not only the air can flow vertically among the fins 22 but also flow horizontally from the opening 220. Thus, the overall heat dissipating effect can be improved by heat transfer and air flow.

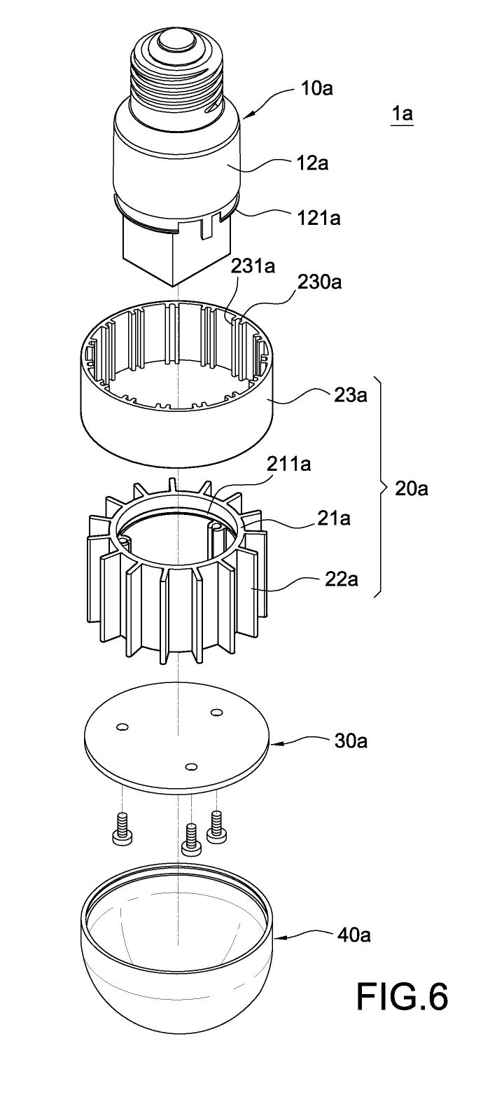

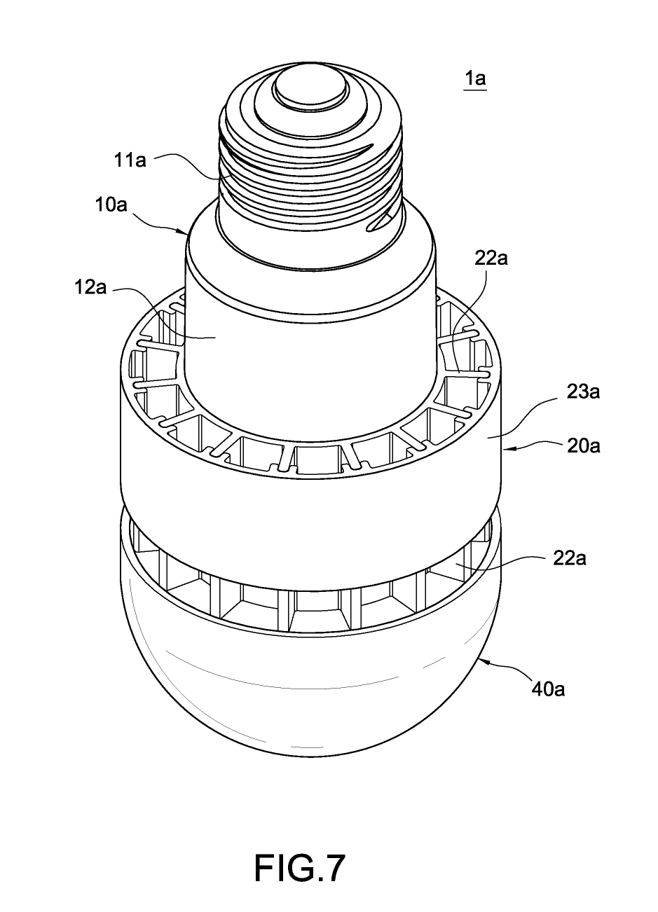

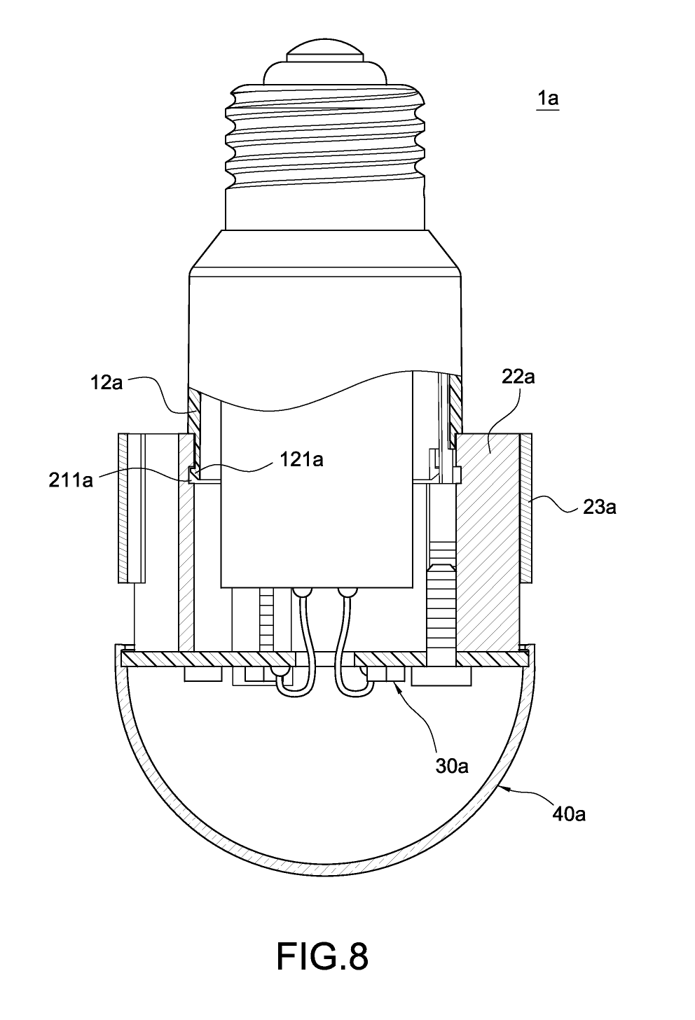

Referring to FIGS. 6 to 8, an exploded view, an exploded view, and a sectional view of the LED bulb according to another embodiment of the present invention are disclosed. The embodiment is similar to the first embodiment described above. The LED bulb 1a also comprises a base 10a, a heat dissipater 20a, a LED module 30a and a cap 40a. The difference is that the heat dissipation ring 23a and the fins 22a of the heat dissipater 20a are positioned apart from one another, and the fins 22a doesn't have any opening to connect to the heat dissipation ring 23a. In this embodiment, there is a plurality of grooves 230a formed on the inner sidewall of the heat dissipation ring 23a corresponding to the fins 22a. Every groove 230a is shaped by the two protrusions 231a separated by an interval. Thus, the fins 22a can respectively fit through the grooves 220a by the outer flange to join with the heat dissipation ring 23a.

The other difference in this embodiment from the previous embodiment is that the positioning structure of the isolation tube 12a and the hollow tunnel 21a. The first positioning portion 121a of the isolation tube 12a is a hook, and the second positioning portion 211a of the hollow tunnel 21a is a groove. The hook is inlayed into the groove to fix the heat dissipater 20a into the base 10a.

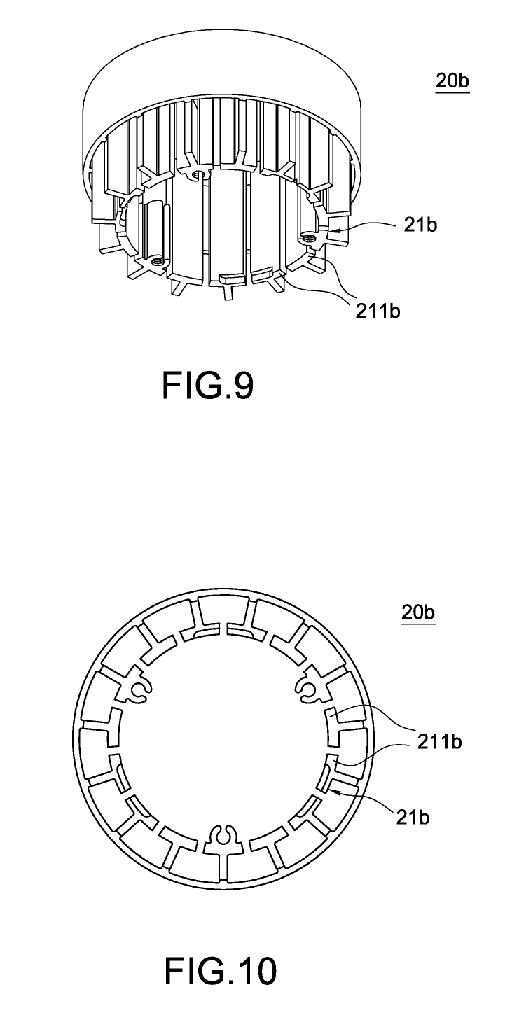

Referring to FIGS. 9 and 10, a perspective view and a top view of the heat dissipater according to another embodiment of the present invention is disclosed. The heat dissipater 20b is different from the previous embodiment in that the hollow tunnel 21b comprises a plurality of plates 211b positioned with interval in there-between, and the plates 211b are positioned in a circular fashion. The interval between the plates 211b can substantially provide the benefit of forming the heat dissipater 20b in one piece.

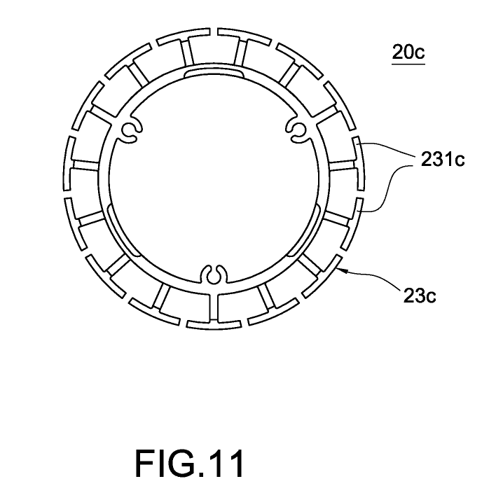

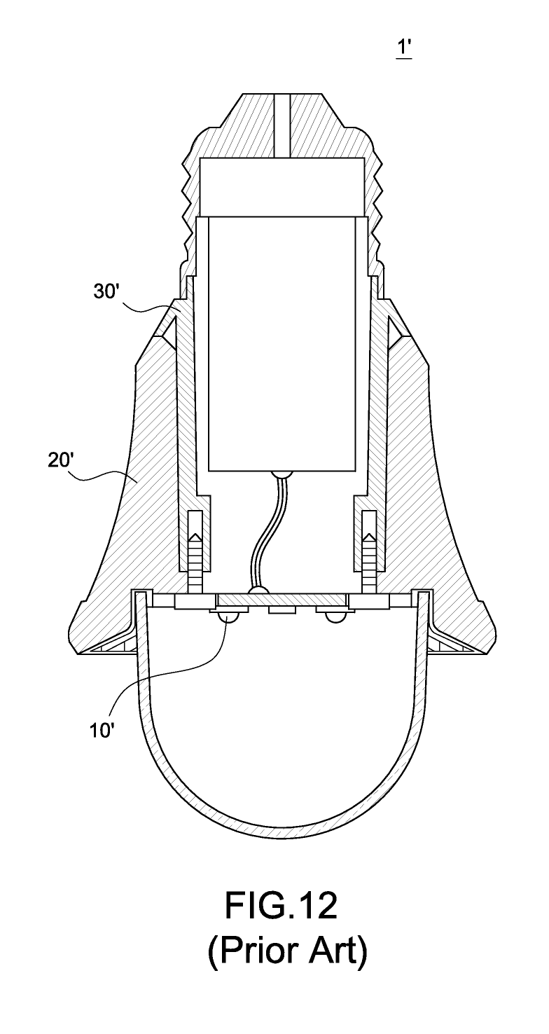

Referring to FIG. 11, a top view of the heat dissipater according to another embodiment of the present invention is disclosed. The heat dissipater 20c in this embodiment is different from the previous embodiment in that the heat dissipation ring 23c comprises a plurality of heat dispensing plates 231c with an interval in there-between. The heat dispensing plates 231c are positioned in a circular fashion. Similar to the other embodiments, the heat dissipation ring 23c comprises an interval in between to benefit forming the heat dissipater 20c in one piece.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A LED bulb having a heat dissipater, said LED bulb comprising:
a base, comprising a conducting portion and an isolation tube positioned at a bottom side of said conducting portion;
a heat dissipater, joining on said isolation tube and having a hollow tunnel; said hollow tunnel having a plurality of fins extending perpendicularly and positioned with an interval from one another in a radial fashion, wherein said fins comprises an outer flange connected to a heat dissipation ring, and said heat dissipation ring circularly connected to said fins;
a LED module, comprising a circuit board fixed to said heat dissipater and a plurality of LED scattered on said circuit board; and
a cap, assembled to said heat dissipater to house said LED module.

2. The LED bulb having a heat dissipater according to claim 1, wherein said isolation tube comprises a bottom portion fitted into an inner portion of said hollow tunnel; said isolation tube comprises a first positioning portion formed corresponding to a second positioning portion formed in an inner sidewall of said hollow tunnel.

3. The LED bulb having a heat dissipater according to claim 2, wherein said first positioning portion comprises a plurality of arch grooves and a plurality of blocks; said second positioning portion comprises a plurality of protrusions and a plurality of grooves; said arch grooves extend upwards from a bottom flange of said isolation tube for a length; said arch grooves have top flanges to support against a top portion of said protrusions; said blocks buckle in said grooves.

4. The LED bulb having a heat dissipater according to claim 1, wherein said heat dispensing ring is positioned on a top side of said fins and only covering a part of said fins.

5. The LED bulb having a heat dissipater according to claim 4, wherein said heat dispensing ring and said hollow tunnel are positioned to form an opening to make said fins and said hollow tunnel only connecting partially.

6. The LED bulb having a heat dissipater according to claim 5, wherein said opening is a V shape groove.

7. The LED bulb having a heat dissipater according to claim 1, wherein said heat dissipation ring and said fins are integrally formed as one piece element.

8. The LED bulb having a heat dissipater according to claim 1, wherein said heat dissipation ring and said fins are formed to position respectively.

9. The LED bulb having a heat dissipater according to claim 8, wherein said heat dissipation ring has a plurality of grooves formed on an inner sidewall corresponding to said fins, and said fins have an outer flange respectively fit in said grooves to join to said heat dissipation ring.

10. The LED bulb having a heat dissipater according to claim 9, wherein said grooves are formed by two protrusions positioned respectively with an interval.

11. The LED bulb having a heat dissipater according to claim 1, wherein said hollow tunnel comprises a plurality of tubular plates positioned with gap from one another, and said tubular plates are positioned in a circular fashion.

12. The LED bulb having a heat dissipater according to claim 1, wherein said heat dissipation ring comprises a plurality of heat dissipating plates positioned with gap from one another, and said heat dissipating plates are positioned in a circular fashion.
